(19) United States
(12) Patent Application Publication
(10) Pub. No.: US 2011/0258523 A1
(43) Pub. Date: Oct. 20, 2011

(54) ELECTRONIC READING APPARATUS AND METHOD FOR FLIPPING THROUGH DISPLAYED FILES

(75) Inventor: Wei Song, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 12/859,285

(22) Filed: Aug. 19, 2010

(30) Foreign Application Priority Data
Apr. 14, 2010 (CN) 201010146838.3

(51) Int. Cl. G06F 3/14

(52) U.S. Cl. 715/201

(57) ABSTRACT

An electronic reading apparatus includes a display unit, and a processing unit. The processing unit is configured to selectively control the electronic reading apparatus to enter a single page mode in which a single page interface is displayed on the display unit. Also enter a multipage mode in which a multipage interface is displayed on the display unit according to user inputs, and to display a page corresponding to a marked page icon in the single page mode when a confirm signal is received from an input unit, the single page interface displaying a set of page icons, each of the page icons corresponding to a page of a file. The multipage interface displaying a set of folder icons, each of the folder icons corresponding to a particular number of continuous pages of the file. A method for flipping through displayed files is also provided.

### BACKGROUND

1. Technical Field

The present disclosure relates to electronic reading apparatuses and, particularly, to an electronic reading apparatus and a method for flipping through displayed files.

2. Description of the Related Art

Conventionally, when flipping through a file displayed on an electronic device such as on an electronic reading apparatus, readers can page through a file by pressing page buttons on the electronic reading apparatus. However this repetitive process may cause the readers to feel tired and bored if they are pressing the page buttons repeatingly.

### BRIEF DESCRIPTION OF THE DRAWINGS

The components of the drawings are not necessarily drawn to scale, the emphasis instead being placed upon clearly illustrating the principles of an electronic reading apparatus and a method for paging through displayed files. Moreover, in the drawings, like reference numerals designate corresponding parts throughout multiple views.

FIG. 1 is a schematic view of an electronic reading apparatus in accordance with an exemplary embodiment.

FIG. 2 is a block diagram of the electronic reading apparatus of FIG. 1.

FIG. 3 is a schematic diagram showing a single page interface provided by the electronic reading apparatus of FIG. 1.

FIG. 4 is another schematic diagram showing a multipage interface provided by the electronic reading apparatus of FIG. 1.

FIG. 5 is a flowchart of a method for flipping through displayed files applied in the electronic reading apparatus of FIG. 1 in accordance with an exemplary embodiment.

### DETAILED DESCRIPTION

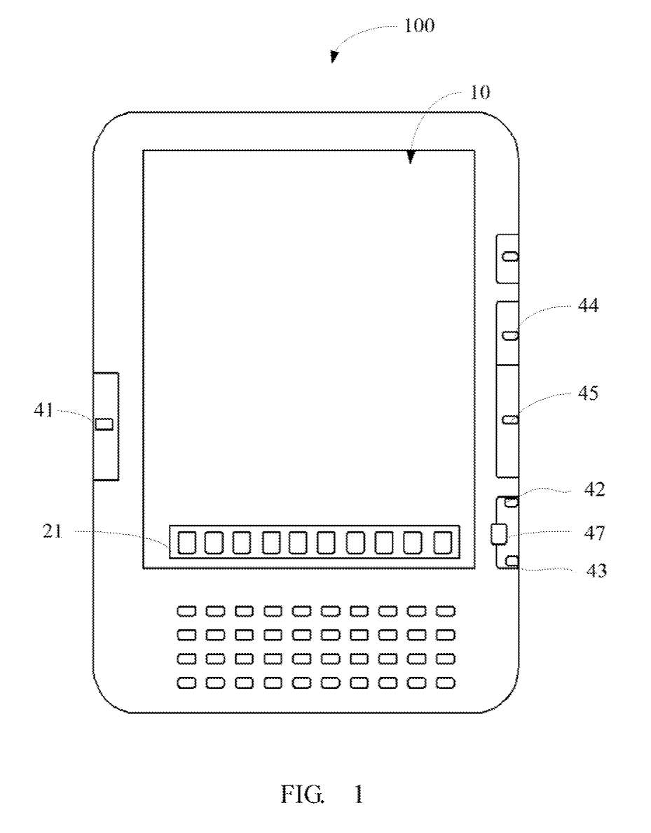

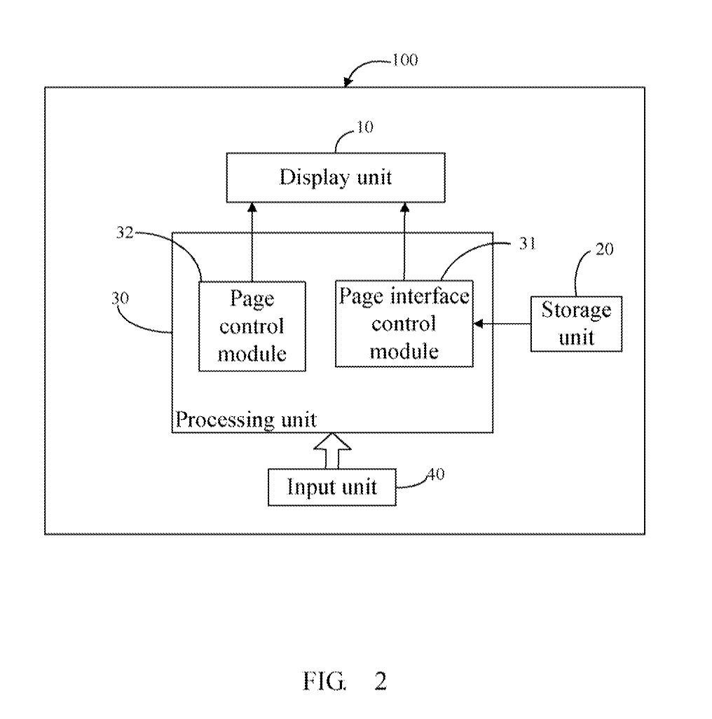

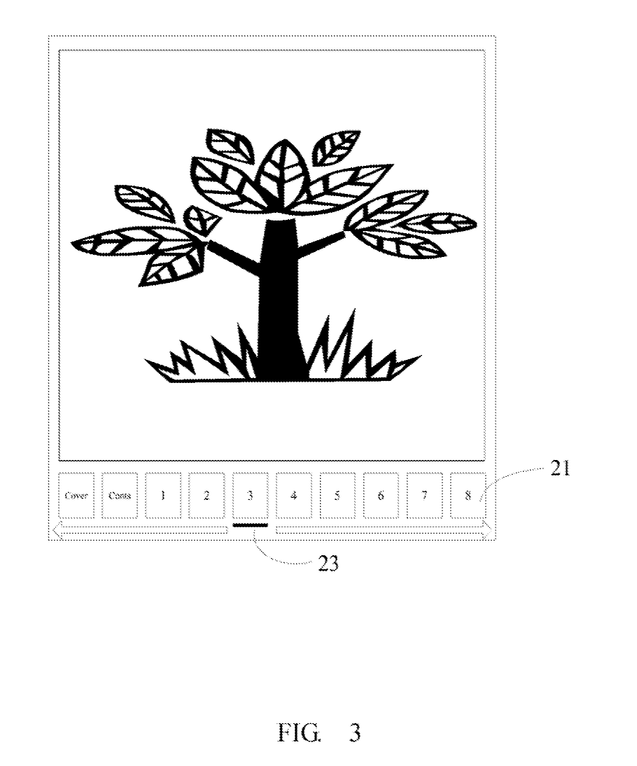

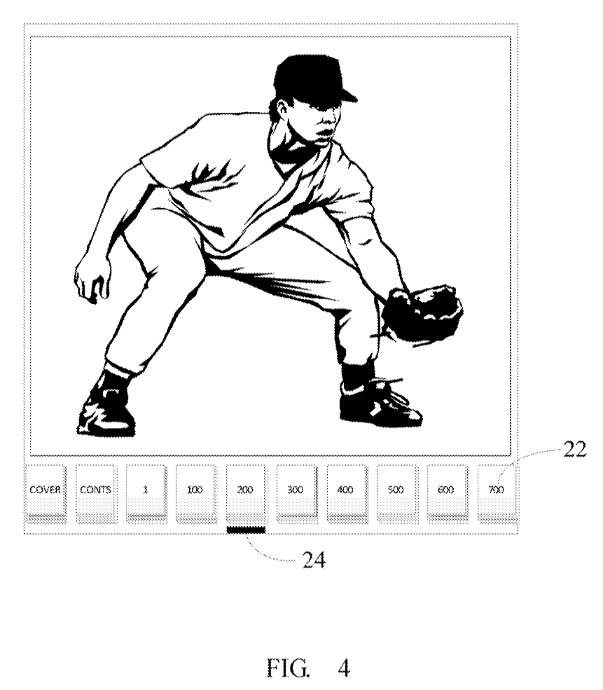

Referring to FIGS. 1 and 2, an electronic reading apparatus 100 includes a display unit 10, a storage unit 20, a processing unit 30, and an input unit 40. In this embodiment, the electronic reading apparatus 100 may be a mobile phone, an E-book, or an audio player. The electronic reading apparatus 100 can operate in a single page mode or a multipage mode. Under the single page mode, the electronic reading apparatus 100 displays a single page interface 21 showing a set of page icons corresponding to a number of continuous pages in a file, as shown in FIG. 3. Each of the page icons corresponds to a page sequence and marked in a way for users to identify the page easily, for example, the page icon is marked with a page number of the page. The page icons are arranged one after another in the single page interface 21 according to the sequence of the pages in the file. The page icons are selectable for users who operate the input unit 40 to open the corresponding page. Referring to FIG. 4, under the multipage mode, the electronic reading apparatus 100 displays a multipage interface 22 showing a set of folder icons. Each of the folder icons corresponds to a folder, which includes a set of continuous pages in a file and is also marked in a way for users to easily identify the pages, for example, the folder icon is marked with a page number of a particular page in the continuous pages. The folder icons are selectable for users who operate the input unit 40 to enter the single page interface 21. The single page interface 21 shows page icons of the continuous pages in the selected folder.

The storage unit 20 is configured to store files. The display unit 10 is configured to display information.

In this embodiment, the input unit 40 may include a mode button 41, two cursor buttons 42 and 43, two page buttons 44 and 45, and a confirm button 47. The mode button 41 is configured to generate a first mode signal for causing the electronic reading apparatus 100 to enter the single page mode, a second mode signal for causing the electronic reading apparatus 100 to enter the multipage mode, and a third mode signal for returning from current mode to the previous mode. In this embodiment, when the mode button 41 is pressed for a first predetermined time interval, the first mode signal is generated. When the mode button 41 is pressed for, a second predetermined time interval, the second mode signal is generated. When the mode button 41 is pressed for, a third predetermined time interval, the third mode signal is generated. The cursor buttons 42 and 43 are configured to generate signals for controlling the movement of a displayed cursor. The two page buttons 44 and 45 are configured to generate page signals to flip pages forward or backward. The confirm button 47 is configured to generate confirm signals.

The processing unit 30 includes a page interface control module 31, and a page control module 32. The page interface control module 31 is configured to control the electronic reading apparatus 100 to enter the single page mode and display the single page interface 21 on the display unit 10 if the first mode signal from the mode button 41 is received. In addition, the page interface control module 31 controls the electronic reading apparatus 100 to enter the multipage mode and display the multipage interface 22 on the display unit 10 if the second mode signal from the mode button 41 is received. When the electronic reading apparatus 100 is in the single page mode, the users can operate the cursor buttons 42 and 43 to move a cursor in the single page interface 21 to mark a desired page. When the electronic reading apparatus 100 is in the multipage mode, the users can operate the cursor buttons 42 and 43 to move a cursor 24 in multipage interface 22 to mark a desired folder. The page interface control module 31 is further configured to control the electronic reading apparatus 100 to enter the single page mode and displays a set of page icons corresponding to continuous pages in the selected folder if a confirm signal is received after a folder is selected. The users also can operate the mode button 41 to return to the previous mode before the current mode if the third mode signal from the mode button 41 is received. For instance, the current mode is single page mode displaying a set page icons of the continuous pages corresponding to a selected folder in the multipage mode, the page interface control module 31 controls the electronic reading apparatus 100 to return to the multipage mode displaying the multipage interface 22 containing the selected folder by operating the mode button 41.

The page control module 32 is configured to display a page corresponding to a marked page icon on the display unit 10. In this embodiment, under the single page mode, if the confirm signal is received after a page icon is selected, i.e., marked, the page control module 32 identifies the page location of a page according to the page icon and displays the page on the display unit 10.

FIG. 3 shows an exemplary example of the single page interface 21. In this embodiment, According to the example of the single page interface 21, a number of page icons marked with “cover”, “catalogue” and numbers “1” through “8” are shown. The page icon marked with “cover” refers to the cover page of a file, the page icon marked with “catalogue” refers to the catalogue page, or pages of the file, and the page icons marked with “1” through “8” refer to pages 1-8 of the main body of the file. A controllable cursor 23 is provided for users who operate the cursor buttons 42 and 43 to mark a desired page icon. A corresponding page is opened if the users operate the confirm button 47. A cursor 23 is also provided for users to change the displayed page icons by moving the cursor 23 to the left-most or the right-most of the single page interface 21 to cause hidden page icons to be displayed.

FIG. 4 shows an example of the multipage interface 22. According to the example of the interface 22, a number of folder icons marked with “cover”, “catalogue” and numbers “1”, “100”, “200” . . . “700”. The folder icon marked with “cover” refers to the cover page of the file. The folder icon marked with “catalogue” refers to the catalogue page or pages of the file. The folder icon marked with “1” refers to pages 1-99 of the main body of the file. The folder icon marked with “100” refers to pages 100-199 of the main body of the file. Likewise, the folder icon marked with “700” refers to pages 700-799 of the main body of the file. In alternative embodiments, the folder icon marked with “1” refers to pages 1-50 of the main body, and the folder icon marked with “100” refers to pages 51 through 150, and likewise the folder icon marked with “700” corresponds to pages 651 through 750. A controllable cursor 24 is also provided for users to mark a desired folder icon. The corresponding folder is opened to bring the users to a single page interface 21. The single page interface 21 displayed in response to the opening of a folder only shows page icons of pages included in the folder. The cursor 24 is also provided for users to change the displayed folder icons by moving the cursor 24 to the left or the right-most of the interface 22 to cause hidden folder icons to be displayed.

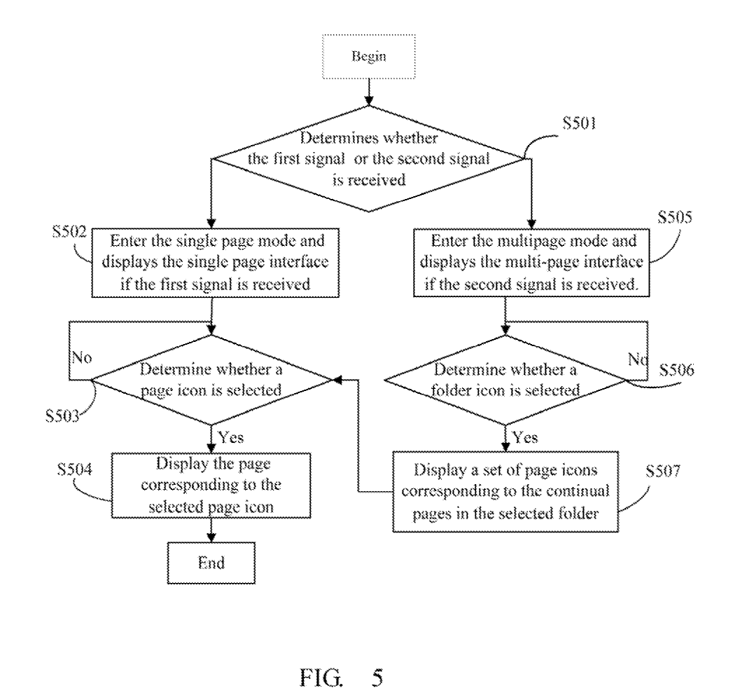

Referring to the FIG. 5, a method for flipping through displayed files is applied in the electronic reading apparatus 100 in accordance with an exemplary embodiment.

In step S501, the page interface control module 31 determines whether the first mode signal for causing the electronic reading apparatus 100 to enter the single page mode or the second mode signal for causing the electronic reading apparatus to enter the multipage mode is received.

If the first mode signal is received, in step S502, the page interface control module 31 controls the electronic reading apparatus 100 to enter the single page mode and displays the single page interface 21. In this embodiment, under the single page mode, the electronic reading apparatus 100 displays a single page interface 21 showing a set of page icons corresponding to a number of continuous pages in a file. Each of the page icons corresponds to a page in the continuous pages and is marked in a way for users to easily identify the page. The page icons are arranged one after another in the single page interface 21 according to the sequence of the pages in the file.

In step S503, the page control module 32 determines whether a page icon is marked and a confirm signal is received when the electronic reading apparatus 100 is in the single page mode. If so, the procedure goes to step S504, otherwise the procedure stays at step S503 if no other types of signals are received.

In step S504, the page control module 32 displays a page corresponding to a marked page icon on the display unit 10, the procedure finishes.

If the second mode signal is received, in step S505, the page interface control module 31 controls the electronic reading apparatus 100 to enter the multipage mode and displays the multipage interface 22. In this embodiment, under the multipage mode, the electronic reading apparatus 100 displays a multipage interface 22 showing a set of folder icons, each of the folder icons corresponds to a folder which includes a set of continuous pages in a file and is also marked in a way for users to easily identify the pages. The folder icons are selectable for users who operate the input unit 40 to enter the single page interface 21. The single page interface 21 shows page icons of the continuous pages in the selected folder.

In step S506, the page interface control module 31 determines whether a folder icon in the multipage interface 22 is marked and a confirm signal is received. If so, the procedure goes to step S507; otherwise the procedure stays at step S506 if no other types of signals are received.

In step S507, the page interface control module 31 controls the electronic reading apparatus 100 to enter the single page mode and display a set of continuous page icons corresponding to the marked folder icon, and then goes to step S503.

In this embodiment, the electronic reading apparatus 100 is navigated from the multipage mode to the single mode when a folder is opened in the multipage mode. The electronic reading apparatus 100 also navigates to return to the multipage mode from the single page mode if the user operates the mode button 41 to produce a third mode signal.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic reading apparatus, comprising:
an input unit configured to generate mode signals and confirm signals according to user inputs.
a display unit configured to display information, and
a processing unit configured to:
selectively control the electronic reading apparatus to enter a single page mode in which a single page interface is displayed on the display unit or to enter a multipage mode in which a multipage interface is displayed on the display unit according to the mode signals, the single page interface displaying a set of page icons, each of the page icons corresponding to a page of a file, the multipage interface displaying a set of folder icons, each of the folder icons corresponding to a particular number of continuous pages of the file;
control the electronic reading apparatus to enter the single page mode and displays a set of page icons corresponding to continuous pages in the selected folder if a confirm signal is received after a folder is selected in the multipage mode; and
display a page corresponding to a marked page icon in the single page mode on the display unit when a confirm signal is received from the input unit.

2. The electronic reading apparatus as claimed in claim 1, wherein the processing unit is further configured to return to the multipage mode from the single page mode according to the mode signals.

3. The electronic reading apparatus as described in claim 2, wherein the input unit comprises a mode button configured to generate a first mode signal for signaling the processing unit to control the electronic reading apparatus to enter the single page mode, and generate a second mode signal for signaling the processing unit to control the electronic reading apparatus to enter the multipage mode, and a third mode signal for signaling the processing unit to control the electronic reading apparatus to return to the multipage mode from the single page mode.

4. The electronic reading apparatus as described in claim 3, wherein when the mode button is depressed for a first predetermined time interval, the first mode signal is generated; when the mode button is depressed for a second predetermined time interval, the second mode signal is generated; and when the mode button is depressed for a third predetermined time interval, the third mode signal is generated.

5. The electronic reading apparatus as described in claim 1, wherein the input unit comprises two cursor buttons configured to generate signals for controlling the movement of a displayed cursor on the single page interface or on the multipage interface.

6. The electronic reading apparatus as described in claim 1, wherein the input unit comprises two page buttons configured to generate page signals to flip pages forward or backward.

7. The electronic apparatus as described in claim 1, wherein the input unit comprises a confirm button configured to generate confirm signals.

8. The electronic reading apparatus as described in claim 1, wherein the single page interface shows a number of page icons marked with “cover”, “catalogue” and numbers, the page icon marked with “cover” refers to the cover page of a file, the page icon marked with “catalogue” refers to the catalogue page or pages of the file, and each of the page icons marked with numbers refers to a particular page of the main body of the file.

9. The electronic reading apparatus as described in claim 1, wherein the multipage interface shows a number of folder icons marked with “cover”, “catalogue” and numbers, the folder icon marked with “cover” refers to the cover page of the file, the folder icon marked with “catalogue” refers to the catalogue page or pages of the file, each of the folder icons marked with a numbers referring to particular page of the main body of the file.

10. The electronic reading apparatus as described in claim 1, wherein the single page interface and the multipage interface displays a controllable cursor for users to mark a desired page icon or a desired folder icon and changing the displayed page icons or the displayed folder icons.

11. A method for flipping through displayed files applied in an electronic reading apparatus, comprising:
determining whether a first mode signal for causing the electronic reading apparatus to enter a single page mode or a second mode signal for causing the electronic reading apparatus to enter a multipage mode is received;
if the first mode signal is received, causing the electronic reading apparatus to enter the single page mode and display a single page interface, the single page interface displaying a set of page icons corresponding to a particular number of continuous pages of a file;
displaying a page corresponding to a marked page icon in the single page mode if a confirm signal is received;
if the second mode signal is received, causing the electronic reading apparatus to enter the multipage mode and display a multipage interface, the multipage interface displaying a set of folder icons, each of the folder icons corresponds to a folder which comprises a set of continuous pages in a file; and
causing the electronic reading apparatus to enter the single page mode to display a set of continuous page icons corresponding to a marked folder icon in the multipage mode if a confirm signal is received;

12. The method as described in claim 11, further comprising a step executed after the electronic reading apparatus enters the single page mode from the multipage mode:
causing the electronic reading apparatus to return to the multipage mode from the single page mode if a third mode signal is received.

13. The method as described in claim 11, wherein the first mode signal is generated when a mode button on the electronic reading apparatus is depressed for a first predetermined time interval, the second mode signal is generated when the mode button is depressed for a second predetermined time interval, and the third mode signal is generated when the mode button is depressed for a third predetermined time interval.

14. The method as described in claim 11, wherein the page icons displayed on the single page interface marked with “cover”, “catalogue” and numbers, the page icon marked with “cover” refers to the cover page of the file, the page icon marked with “catalogue” refers to the catalogue page or pages of the file, and each of the page icons marked with numbers refers to a particular page of the main body of the file.

15. The method as described in claim 11, wherein the multipage interface shows a number of folder icons marked with “cover”, “catalogue” and numbers, the folder icon marked with “cover” refers to the cover page of the file, the folder icon marked with “catalogue” refers to the catalogue page or pages of the file, each of the folder icons marked with numbers refers to particular pages of the main body of the file.

16. An electronic reading apparatus, comprising:
a display unit configured for displaying information, and
a processing unit is configured to selectively control the electronic reading apparatus to enter a single page mode in which a single page interface is displayed on the display unit or to enter a multipage mode in which a multipage interface is displayed on the display unit according to user inputs, and to display a page corresponding to a marked page icon on the display unit in the single page mode when a confirm signal is received from an input unit, the single page interface displaying a set of page icons, each of the page icons corresponding to a page of a file, the multipage interface displaying a set of folder icons, each of the folder icons corresponding to a particular number of continuous pages of the file.

17. The electronic reading apparatus as described in claim 16, wherein the processing unit controls the electronic reading apparatus to enter the single page mode to display page icons on the display unit when a confirm signal is received from an input unit, the page icons corresponding to the particular number of continuous pages of a marked folder icon in the multipage mode.

18. The electronic reading apparatus as described in claim 16, wherein the processing unit is further configured to return to the multipage mode from the single page mode according to the mode signals.

19. The electronic reading apparatus as described in claim 16, wherein the single page interface shows a number of page icons marked with “cover”, “catalogue” and numbers, the page icon marked with “cover” refers to the cover page of the file, the page icon marked with “catalogue” refers to the catalogue page or pages of the file, and each of the page icons marked with numbers refer to a particular page of the main body of the file; the multipage interface shows a number of folder icons marked with “cover”, “catalogue” and numbers, the folder icon marked with “cover” refers to the cover page of the file, the folder icon marked with “catalogue” refers to the catalogue page or pages of the file, each of the folder icons marked with numbers refers to particular pages of the main body of the file; the single page interface and the multipage interface also shows a controllable cursor for users to mark a desired page icon or a desired folder icon and changing the displayed page icons or the displayed folder icons.
